(19) United States
(12) Patent Application Publication
(10) Pub. No.: US 2012/0274294 A1
(43) Pub. Date: Nov. 1, 2012

(54) CONTROLLER FOR CONVERTING CIRCUIT

(75) Inventors: Li-Min LEE, New Taipei City (TW); Chung-Che YU, New Taipei City (TW); Shian-Sung SHIU, New Taipei City (TW); Quan GAN, Wuxi (CN)

(73) Assignee: GREEN SOLUTION TECHNOLOGY CO., LTD., New Taipei City (TW)

(21) Appl. No.: 13/175,946

(22) Filed: Jul. 4, 2011

(30) Foreign Application Priority Data
Apr. 26, 2011 (CN) 201110114194.4

(51) Int. Cl. G05F 1/00

(52) U.S. Cl. 323/282; 323/265

(57) ABSTRACT

A control circuit adapted to a DC-DC converting circuit is disclosed. The controller comprises a reference voltage generator, a reference voltage adjusting circuit, a feedback circuit and a driving circuit. The reference voltage adjusting circuit generates an adjusted reference voltage according to a reference voltage generated by the reference voltage generator. The feedback circuit generates a feedback control signal according to the adjusted reference voltage and the feedback signal. The driving circuit generates at least one control signal for controlling the converting circuit according to the feedback control signal.

### RELATED APPLICATIONS

This application claims priority to China Application Serial Number 201110114194.4, filed Apr. 26, 2011, which is herein incorporated by reference.

### BACKGROUND

1. Technical Field

The present invention relates to a control circuit for a converting circuit, and more particularly, to a control circuit for restraining noise interference.

2. Description of Related Art

FIG. 1 is a schematic diagram of a conventional DC (direct current) to DC (direct current) converting circuit (converter). The DC to DC converter comprises a controller 10, two switches M1 and M2, an inductance L, a capacitance C, a bootstrap circuit BS and a voltage divider VD, and is a step-down converting circuit. The voltage divider VD detects an output voltage Vout of the step-down converting circuit to generate a feedback signal FB accordingly. The controller 10 switches the switches M1 and M2 according to the feedback signal FB, so that the converting circuit converts an input voltage Vin into the output voltage Vout at a predetermined voltage.

The controller 10 comprises a comparator 12, a constant on-time circuit 14, a logic control circuit 16 and two gate driving units 18 and 20. The comparator 12 receives the feedback signal FB and a reference voltage Vref, and generates a feedback control signal. The constant on-time circuit 14 generates a constant on-time signal according to the feedback control signal. The logic control circuit 16 determines start points and end points of turning on the switches M1 and M2 in each cycle, and also switches on or off the switches M1 and M2 through the gate driving units 18 and 20 respectively. Since the switch M2 is NMOSFET, the gate driving unit 20 has to provide a signal with sufficient voltage level to turn on the switch M2. The bootstrap circuit BS can ensure that the gate driving unit 20 can provide sufficient voltage level to turn on the switch M2.

Since the comparator 12 may be malfunctioned due to noises in the circuit, the comparator 12 may be designed with a hysteresis range to avoid the interference of the noises. Because the reference voltage Vref is a constant value, a voltage divider ratio of the voltage divider VD must be modulated in response to different output voltages Vout provided by the converting circuit. Hence, a voltage ripple of the output voltage due to the hysteresis range of the comparator 12 may be multiplied by the reciprocal of the voltage divider ratio.

### SUMMARY

In the foregoing related art, the method of setting the hysteresis range of the comparator to avoid the noise may lead to different voltage ripples due to different output voltages. The invention adjusts the reference voltage in response to the output voltage, so as to effectively restrain the voltage ripple.

To accomplish the aforementioned and other objects, an exemplary embodiment of the invention provides a control circuit adapted to control a converting circuit which converts an input voltage to an output voltage. The control circuit comprises a reference voltage generating circuit, a reference voltage adjusting circuit, a feedback circuit, and a driving circuit. The reference voltage generating circuit generates a reference voltage. The reference voltage adjusting circuit adjusts the reference voltage to generate an adjusted reference voltage according to the output voltage. The feedback circuit generates a feedback control signal according the adjusted reference voltage and a feedback signal indicating the output voltage. The driving circuit generates at least one control signal for controlling the converting circuit according to the feedback control signal.

Furthermore, another exemplary embodiment of the invention provides a control circuit adapted to control a converting circuit which converts an input voltage to an output voltage. The control circuit comprises a reference voltage generating circuit, a reference voltage adjusting circuit, a feedback circuit, and a driving circuit. The reference voltage generating circuit generates a reference voltage. The reference voltage adjusting circuit is coupled with the reference voltage generating circuit to adjust the level of the reference voltage. The feedback circuit generates a feedback control signal according the adjusted reference voltage and a feedback signal indicating the output voltage. The driving circuit generates at least one control signal for controlling the converting circuit according to the feedback control signal.

It is to be understood that both the foregoing general description and the following detailed description are exemplary, and are intended to provide further explanation of the invention as claimed. In order to make the features and the advantages of the invention comprehensible, exemplary embodiments accompanied with figures are described in detail below.

### BRIEF DESCRIPTION OF THE DRAWINGS

The present invention will now be specified with reference to its preferred embodiment illustrated in the drawings, in which:

FIG. 1 is a schematic diagram of a conventional DC-DC converting circuit;

FIG. 2 is a schematic diagram of a control circuit for a DC-DC converter according to the first embodiment of the invention; and

FIG. 3 is a schematic diagram of a control circuit for a DC-DC converter according to the second embodiment of the invention;

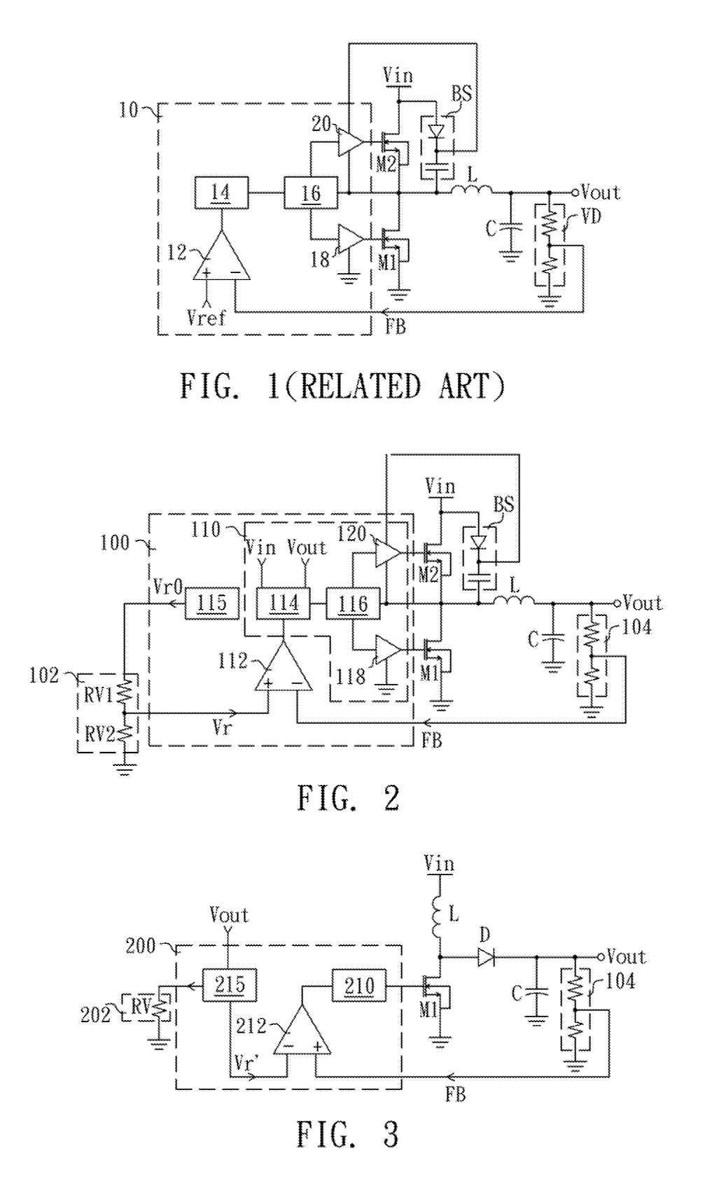

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

FIG. 2 is a schematic diagram of a DC-DC converting circuit according to the first embodiment of the invention. The DC-DC converting circuit comprises a control circuit and a converting circuit. The control circuit comprises a controller 100 and a reference voltage adjusting circuit 102. In the present embodiment, the converting circuit comprises two switches M1 and M2, an inductance L, a capacitance C, and a bootstrap circuit BS. The controller 100 switches the switches M1 and M2 between on state and off state so as to convert an input voltage Vin into an output voltage Vout by using the inductance L and the capacitance C. The voltage detecting circuit 104 is coupled with the converting circuit to generate a feedback signal FB according to the output voltage Vout.

The controller 100 comprises a reference voltage generating circuit 115, a feedback circuit 112 and a driving circuit 110, wherein the driving circuit 110 comprises a constant time circuit 114, a logical control circuit 116 and two gate driving units 118 and 120. The reference generating circuit 115 is used to generate a reference voltage Vr0. The reference voltage adjusting circuit 102 adjusts the reference voltage Vr0 to generate an adjusted reference voltage Vr. The feedback circuit 112 generates a feedback control signal according to the adjusted reference voltage Vr0 and the feedback signal FB. The driving circuit 110 generates at least one control signal to switch on or off the switches M1 and M2 of the converting circuit.

In the present embodiment, the feedback circuit 112 comprises a comparator. A non-inverting terminal of the comparator receives the adjusted reference voltage Vr, and an inverting terminal thereof receives the feedback signal FB. The comparator generates and outputs a feedback control signal to the constant time circuit 114 when the level of the feedback signal FB is lower than the level of the adjusted reference voltage Vr. In the present embodiment, the constant time circuit is a constant on-time circuit which generates a pulse with a constant width, i.e., a constant time period, when receiving the feedback control signal. Therefore, the switch M2 is turned on for a constant time period for transmitting the electric power from the input voltage Vin into the converting circuit. Since the on-times of the switches M1 and M2 is dependent on the output voltage and the input voltage, an operation frequency of the controller is varied with the output voltage and the input voltage by the means of the constant on-time control technique. The constant time circuit 114 may adjust the length of the constant time period according to the output voltage Vout and the input voltage Vin, thereby achieving fixed-frequency operation.

In principle, the voltage detecting circuit 104 does not need to adjust the ratio of the feedback signal FB and the output voltage of the invention, i.e., does not need to adjust the voltage divider ratio of the voltage detecting circuit 104. Through the reference voltage adjusting circuit 102, the voltage detecting circuit 104 can provide a different level of the feedback signal FB according to the output voltage Vout. On the contrary, in the conventional arts, the voltage divider ratio of the voltage detecting circuit has to be adjusted under different output voltage application to match a constant voltage level of the reference voltage. Therefore, in the present invention, a voltage ripple of the output voltage Vout determined by the hysteresis range of the feedback circuit 112 and the voltage divider ratio of the voltage detecting circuit 104 can be fixed regardless of different output voltage application. In the present invention, the voltage detecting circuit 104 comprises resistors RV1 and RV2 connected in series.

FIG. 3 is a schematic diagram of a DC-DC converting circuit according to the second embodiment of the invention. The DC-DC converting circuit comprises a control circuit and a converting circuit. The control circuit comprises a controller 200 and a reference voltage adjusting circuit 202. The converting circuit comprises a switch M1, a diode D, an inductance L and a capacitance C, and converts an input voltage Vin to an output voltage Vout. A voltage detecting circuit 204 is coupled with the converting circuit to generate a feedback signal FB according to the output voltage Vout. Compared with the embodiment shown in FIG. 2, the main difference is described as follows.

The controller 200 comprises a reference voltage generating circuit 215, a feedback circuit 212 and a driving circuit 210. The reference voltage adjusting circuit 202 is coupled with the reference voltage generating circuit 215. In the present embodiment, the reference voltage adjusting circuit 202 comprises a resistor RV. The reference voltage generating circuit 215 adjusts the level of the reference voltage (Vr′) according to the resistance of the reference voltage adjusting circuit 202. The feedback circuit 212 comprises a comparator. An inverting terminal of the comparator receives the reference voltage Vr′, and a non-inverting terminal thereof receives the feedback signal which is generated by the voltage detecting circuit 204. The comparator outputs a feedback control signal to the driving circuit 210 when the level of the feedback signal FB is higher than that of the reference voltage Vr′. In the present invention, the driving circuit 210 is a constant off-time driving circuit. The driving circuit 210 cuts off the switch M1 for a fixed time period to stop transmitting the electric energy from the input voltage Vin into the converting circuit when receiving the feedback control signal generated by the feedback circuit 212. Because both of the different output voltage and input voltage affect the duty cycle of the switch M1, the operation frequency of the controller is varied with the output voltage and the input voltage by the means of the constant off-time control technique. The driving circuit 210 may adjust the length of the constant time period according to the output voltage Vout and the input voltage Vin, thereby achieving fixed-frequency operation.

Similarly, the voltage detecting circuit 204 does not adjust the ratio of the feedback signal FB and the output voltage. Through the reference voltage adjusting circuit 202, the voltage detecting circuit 204 provides/adjusts different reference voltages according to the output voltage Vout. Therefore, a voltage ripple of the output voltage Vout is independent of the output voltage Vout.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A control circuit adapted to a DC-DC converting circuit which converts an input voltage to an output voltage, the control circuit comprising:
a reference voltage circuit for generating a reference voltage;
a reference voltage adjusting circuit for adjusting the reference voltage according to the output voltage to generate a adjusted reference voltage;
a feedback circuit for generating a feedback control signal according to the adjusted reference voltage and a feedback signal indicating the output voltage; and
a driving circuit for generating at least one controlling signal to control the converting circuit according to the feedback control signal.

2. The control circuit according to claim 1, wherein the reference voltage adjusting circuit comprises at least one resistor.

3. The control circuit according to claim 2, wherein the reference voltage adjusting circuit is a voltage divider, and a voltage-divider ratio thereof is determined according to the output voltage.

4. The control circuit according to claim 1, wherein the feedback circuit comprises a comparator which receives the feedback signal and the adjusted reference voltage to generate the feedback control signal, and the driving circuit is a constant on-time driving circuit or a constant off-time driving circuit which, according to the feedback control signal, transmits or stops transmitting an electric energy from the input voltage into the converting circuit a constant time period in each cycle.

5. The control circuit according to claim 4, wherein the constant time period is determined according to the input voltage and the output voltage.

6. A control circuit, adapted to a DC-DC converting circuit which converts an input voltage to an output voltage, the control circuit comprising:
a reference voltage circuit for generating a reference voltage;
a reference voltage adjusting circuit coupled with the reference voltage circuit to adjust the level of the reference voltage according to the output voltage;
a feedback circuit for generating a feedback control signal according to the adjusted reference voltage and a feedback signal indicative of the output voltage; and
a driving circuit for generating at least one controlling signal to control the converting circuit according to the feedback control signal.

7. The control circuit according to claim 6, wherein the reference voltage adjusting circuit comprises at least one resistor.

8. The control circuit according to claim 7, wherein the reference voltage adjusting circuit is a voltage divider, and a voltage divider ratio thereof is determined according to the output voltage.

9. The control circuit according to claim 6, wherein the feedback circuit comprises a comparator which receives the feedback signal and the adjusted reference voltage, and the driving circuit is a constant on-time driving circuit or a constant off-time to transmit or stop transmitting an electric energy from the input voltage into the converting circuit a constant time period in each cycle according to the feedback control signal.

10. The control circuit according to claim 9, wherein the constant time period is determined according to the input voltage and the output voltage.
